(19) United States
(12) Patent Application Publication
(10) Pub. No.: US 2024/0342652 A1
(43) Pub. Date: Oct. 17, 2024

(54) CARBON CAPTURE AND CONVERSION PROCESS

(71) Applicant: Schlumberger Technology Corporation, Sugar Land, TX (US)

(72) Inventors: Manuel Marya, Sugar Land, TX (US); Alireza Zolfaghari, Sugar Land, TX (US)

(21) Appl. No.: 18/298,862

(22) Filed: Apr. 11, 2023

(51) Int. Cl. B01D 53/86; B01F 33/451

(52) U.S. Cl. CPC B01D 53/8671; B01D 53/869; B01F 33/451; B01D 2255/1021; B01D 2255/104; B01D 2255/202; B01D 2255/20753; B01D 2255/20761; B01D 2255/2094; B01D 2255/2096; B01D 2257/504; B01F 2101/45

(57) ABSTRACT

Methods and systems are provided for producing solid carbon from carbon dioxide and/or hydrocarbons such as methane (CH₄). A metallic media, either in liquid or semi-liquid (semi-solid) form and having a range of liquid and semi-liquid metallic chemistries, is used alone or in combinations with other liquid or semi-liquid metalin a reactive metallurgical process for carbon capture and conversion.

### BACKGROUND

Fossil fuel combustion is a major contributor to the increasing concentration of greenhouse gases (GHGs) in the Earth's atmosphere, which has led to global warming. Burning fossil fuels by combustion, including coal, oil, and natural gas results in the release of greenhouse gases (GHG) such as carbon dioxide (CO₂), nitrous oxide (N₂O), unconsumed methane (CH₄), among others.

Carbon capture processes captures CO₂ emissions from industrial processes and power plants, preventing them from being released into the atmosphere. Instead, the captured CO₂ is stored in underground geological formations or used in various industrial processes.

Current carbon capture/storage technology is greatly limited by the rates of CO₂ that can be readily captured and transformed and most commonly requires considerable industrial footprint. The process of capturing and storing or utilizing CO₂ inherently requires significant energy and resources, making the process of capturing and storing expensive, resource intensive, and not yet totally attractive. Amine absorption of CO₂ is the most mature capture technology.

One alternative is to reduce CO₂ to a solid carbon product. Recent approaches have used electrolyzed liquid metal catalysts to reduce carbon dioxide to solid carbon and molecular oxygen. However, catalytic reduction based on electrochemical approaches are typically inefficient and have less surface area for the catalytic sites (low surface to volume ratio). The process is energy intensive and requires complex infrastructure to conduct on an industrial scale.

Additionally, these approaches to CO₂ reduction often suffer from other difficulties such as lowering the energy barrier of CO₂ activation, poor and slow conversion rates of CO₂, poor durability of catalysts due to the coking of active sites, poor selectivity for specific species, and poor affinity between catalytic surfaces and CO₂ gas.

### SUMMARY

According to one aspect of the present invention, methods and systems are provided for producing solid carbon from carbon dioxide and/or hydrocarbons such as methane (CH₄). A metallic media, either in liquid or semi-liquid (semi-solid) form and having a range of liquid and semi-liquid metallic chemistries, is used alone or in combinations with other liquid or semi-liquid metals, in a reactive metallurgical process for carbon capture and conversion.

According to one aspect of the present invention, a reactive metallurgical process for carbon capture and conversion comprises (a) one or more liquid or semi-liquid media, (b) in-situ formed catalytic intermetallic clusters, and (c) a mass flow of carbon-rich fluid. The relative movements of the various media lead to carbon extraction and separation.

According to one aspect of the present invention, a system for carbon capture and conversion comprises a reactor that incorporates multiple process chambers and novel methods of media blending the semi-liquid media to accelerate carbon conversion. The systems make use of contactless induction methods that are uniquely compatible with liquid and semi-liquid metals to controllably produce mass flow in desired directions, thereby improving overall process capture and conversion efficiency.

Other aspects of the invention will be apparent from the following description and the appended claims.

### BRIEF DESCRIPTION OF DRAWINGS

FIG. 1 shows a reactor for carbon conversion in accordance with one or more embodiments of the invention.

FIG. 2 shows a reactor having multiple chambers in accordance with one or more embodiments of the invention.

FIG. 3 shows alternative reactors for carbon conversion in accordance with one or more embodiments of the invention.

FIG. 4A and FIG. 4B show reactor diagrams in accordance with one or more embodiments of the invention.

FIG. 5A and FIG. 5B show reactor diagrams including lines of applied forces in accordance with one or more embodiments of the invention.

FIG. 6 shows temperature dependence of solubility of intermetallic clusters in a gallium media in accordance with one or more embodiments of the invention.

FIG. 7 shows a chart of reactor column pressure versus height under standard conditions in accordance with one or more embodiments of the invention.

FIG. 8 shows a phase diagram for a tin-bismuth eutectic system in accordance with one or more embodiments of the invention.

FIG. 9 shows a phase diagram for a bismuth-gallium eutectic system in accordance with one or more embodiments of the invention.

FIG. 10 shows a flow chart of a process for carbon conversion in accordance with one or more embodiments of the invention.

Like elements in the various figures are denoted by like reference numerals for consistency.

### DETAILED DESCRIPTION

In general, embodiments are directed to methods and systems for producing solid carbon from carbon dioxide and/or hydrocarbons, such as methane (CH₄). A metallic media, either in liquid or semi-liquid (semi-solid) form and having a range of liquid and semi-liquid metallic chemistries, is used alone or in combinations with other liquid or semi-liquid metals, in a reactive metallurgical process for carbon capture and conversion.

A reactive metallurgical process for carbon capture and conversion comprises (a) one or more liquid or semi-liquid media, (b) in-situ formed catalytic intermetallic clusters, and (c) a mass flow of carbon-rich fluid. The relative movements of the various media lead to carbon extraction and separation.

Systems for carbon capture and conversion comprise a reactor that incorporates multiple process chambers and methods of media blending the semi-liquid media to accelerate carbon conversion. The systems make use of contactless induction methods that are compatible with liquid and semi-liquid metals to controllably produce mass flow in desired directions, thereby improving overall process capture and conversion efficiency.

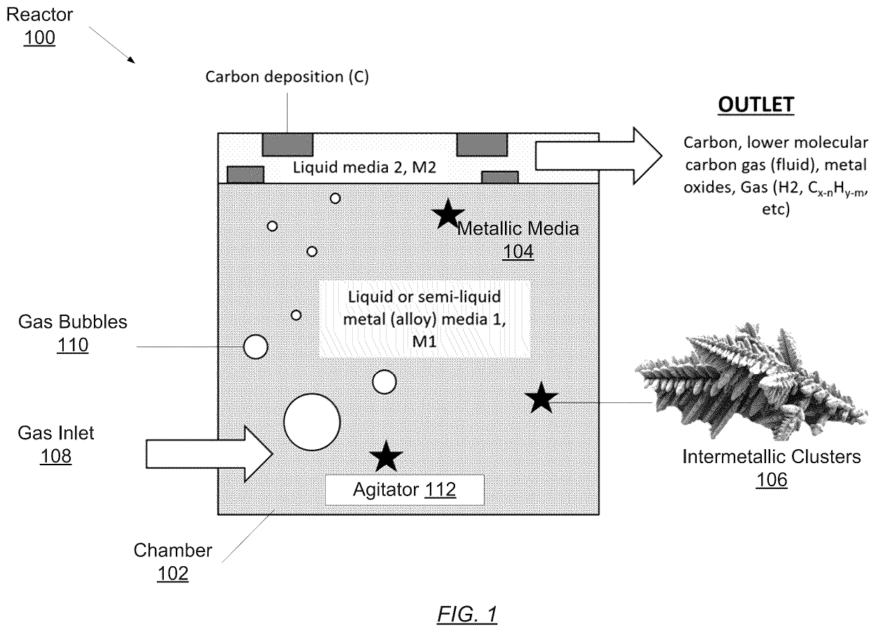

Turning to FIG. 1, reactor for methane (CH₄) conversion to hydrogen (H₂) and carbon is illustrated. The reactor (100) is used for various chemical processes, including the conversion of methane into hydrogen and carbon, and/or the conversion of carbon dioxide into oxygen and carbon. For example, the reactor (100) can be used for performing a reactive metallurgical process for carbon capture and conversion.

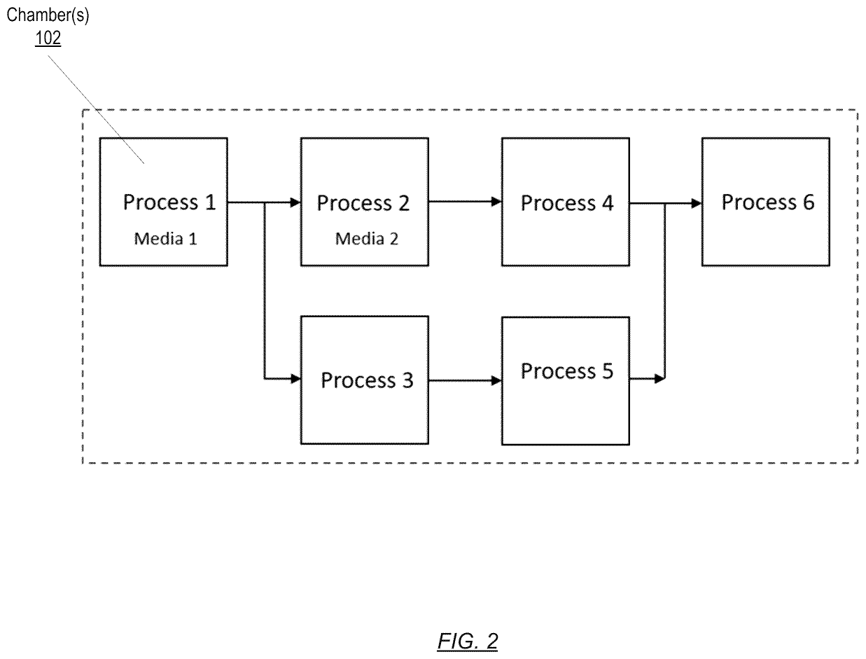

The reactor (100) includes a chamber (102) filled with a metallic media (104). The reactor may include one or more chambers containing one or more metallic media under controlled conditions. The one or more chambers may be configured in series and/or parallel. For example, FIG. 2 illustrates a reactor having six processes and multiple chambers, including two process chambers (e.g., process chamber 2 and process chamber 3) in parallel. The one or more chambers may be complemented by standard fluidic equipment such as pumps, valves, regulator, pressure-temperature gauges, etc.

Returning to FIG. 1, the chamber (102) contains metallic media (104) and optionally one or more complementary media. The metallic media (104) includes a liquid or semi-liquid (also sometimes referred to as a semi-solid) metallic media. As is known in the art, a “semi-liquid” metallic media is a type of material that exhibits properties of both liquids and solids. Semi-liquid metallic media can exhibit both solid-like and liquid-like behavior. For example, a semi-liquid metallic media can flow like a liquid and take on the shape of metallic media's container, and also resist deformation and maintain the metallic media's shape like a solid.

The metallic media (104) can include intermetallic clusters (106) that are formed in situ and disposed in the metallic media (104). The intermetallic clusters (106) include one or more metals or metalloid elements that are soluble within the metallic media (104) under reaction conditions (i.e., temperature and pressure).

A gas inlet (108), also sometimes referred to as a gas distributor, is equipped at the bottom of the reactor (100). The gas inlet (108) can be static mechanical inlets (e.g., chamber inlets) and/or dynamic mechanical inlets (e.g., a perforated spindle) for introducing a carbon gas into the reactor (100).

Carbon gas is introduced through the gas inlet (108), creating more or less readily gas bubbles (110) that depending upon hydrostatic pressure rise more or less rapidly through the metallic media (104). Carbon gas circulating through the metallic media (104) provide the reactants to the carbon conversion process.

Movement of the gas bubbles (110) through the metallic media (104) facilitates mixing and mass transfer between the gas and liquid phases. As the gas bubbles (110) rise through the metallic media (104), the bubbles are exposed to a high surface area of the liquid, which facilitates the chemical reactions that break down the gas into the gas' constituent elements. The intermetallic clusters (106) disposed in the metallic media (104) provide catalytic site surfaces that help to lower the activation energy, allowing carbon conversion to proceed at lower temperatures and pressures than would be required without a catalyst.

Carbon materials that form on the surface of the catalyst are mechanically removed, in part due to agitation as the gas bubbles move through the metallic media (104). Carbon materials that are sloughed from the catalytic surfaces migrate to the top of the reactor due to the density difference of the carbon materials relative to that of metallic components. The solid carbon can then be harvested from the reactor.

In some embodiments, the metallic media (104) is not dispersed in other non-metallic liquids. Rather, the metallic media (104) is provided alone in liquid or semi-liquid (semi-solid), or in combinations with other liquid or semi-liquids. Because liquid metals may not be provided as a solute, or exceed normal solubility in the metallic media (104), and thus may be challenging to disperse, the use of energetic mass exchanges is beneficial to overcome challenges in terms of flow and pressure for a light gas to flow in the dense metallic media (104).

An agitator (112) is configured to induce mass flow. The agitator (112) provides an energetic mass exchange to overcome challenges of a light gas to flow through the liquid metallic media (104). As described in greater detail below, the agitator (112) supplies fluid agitation using magnetic, electric, mechanical means to accelerate reactive process(es), carbon capture, and conversion kinetics.

The one or more agitators (112) promote gas—liquid media reactions and product separation, and as part of a general reactor that may involve multiple chambers, fluids, exchange media and methods of mass exchanges. For example, fluid agitation can be supplied using magnetic, electric, mechanical means to accelerate reactive process(es) and carbon capture and conversion kinetics.

The efficiency of carbon conversion in a molten-metal reduction process depends on several factors, including the composition and temperature of the gas mixture, the type of metal catalyst used, and the design of the column itself. For example, the conversion values listed in Table 1 were obtained under constant reactor conditions of 1000 degrees C., flowed over a molten metal column of 38.5 mm.

TABLE 1
Methane CH₄ pyrolysis at 1000°
C. over 38.5 mm² of molten metal.

| Liquid Catalyst | H₂ Production (mol * cm⁻²s⁻¹) |
|---|---|
| In | 8.2*10⁻¹¹ |
| Bi | 8.2*10⁻¹¹ |
| Sn | 8.5*10⁻¹⁰ |
| Ga | 3.2*10⁻⁹ |
| Ag | 4.3*10⁻⁹ |
| 17% Cu—Sn | 3.1*10⁻⁹ |
| 17% Pt—Sn | 1.6*10⁻⁹ |
| 62% Pt—Bi | 4.2*10⁻⁹ |
| 17% Ni—In | 6.5*10⁻⁹ |
| 17% Ni—Sn | 4.7*10⁻⁹ |
| 73% Ni—In | 5.6*10⁻⁹ |
| 17% Ni—Ga | 6.4*10⁻⁹ |
| 17% Ni—Pb | 7.9*10⁻⁹ |
| 17% Ni—Bi | 9.0*10⁻⁸ |
| 27% Ni—Au | 1.2*10⁻⁸ |
| 27% Ni—Bi | 1.7*10⁻⁸ |

The reported reaction rates of Table 1 can be applied implicitly to various liquid temperatures. For example, the rate of methane reduction at elevated temperatures, liquid metals, and catalysts in order to produce high reaction rates.

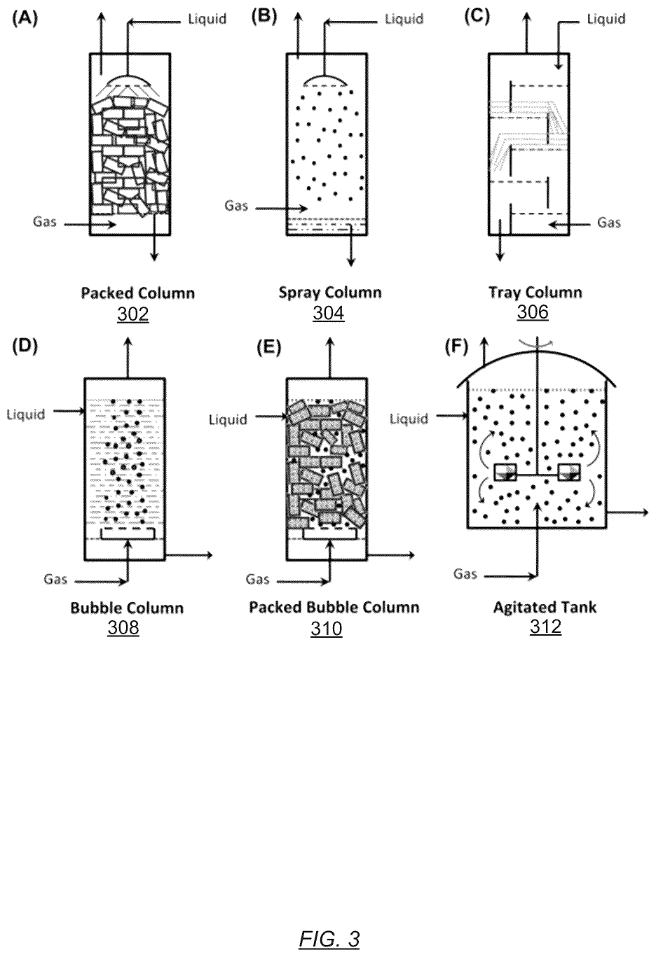

While FIG. 1 illustrates a bubble column reactor, other reactors are also contemplated such as the reactors illustrated in FIG. 3. For example, the reactor may be a packed column, (302), a spray column (304), a tray column (306), bubble column (308), packed bubble column (310), or agitated tank (312).

For example, using a tray column (306), metallic media (104) in FIG. 1 is fed over arrays of plates in a carbon-gas environment, The resulting movement and reaction of the metallic media (104) accumulates and segregates carbon product towards specific chamber or reactor outlets, such as the one or more chambers of FIG. 2.

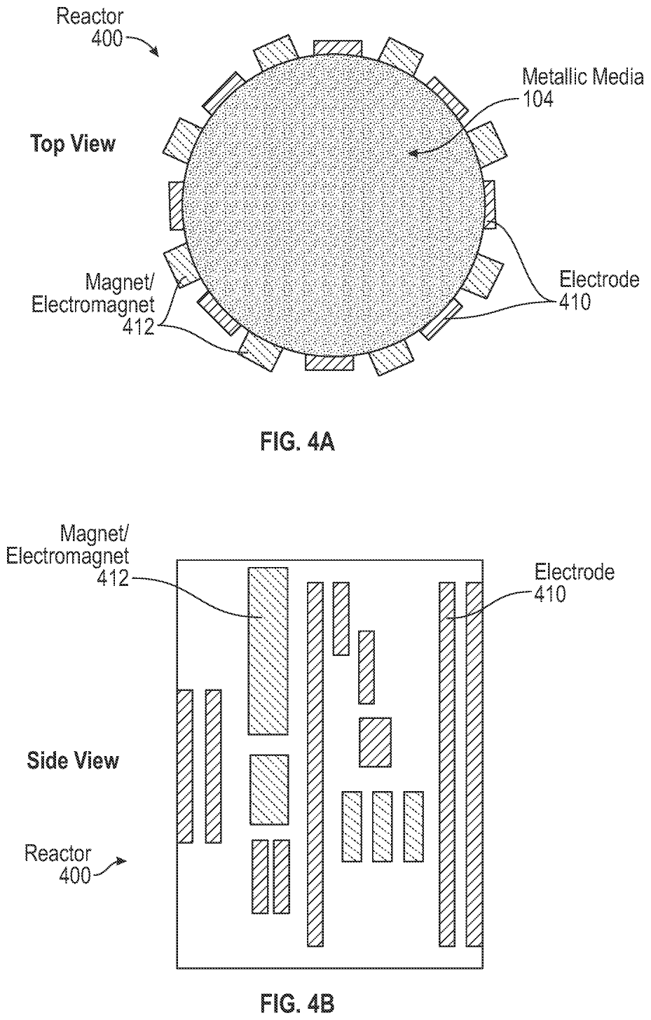

Referring now to FIG. 4A and FIG. 4B, a diagram of a reactor is shown according to illustrative embodiments. The reactor (400) is an example of the reactor (100) illustrated in FIG. 1. The reactor (400) is shown from a both a top view (FIG. 4A) and side view (FIG. 4B) thereof.

The reactor (400) can be made of a non-magnetic material, such as ceramic or quartz. A series of electrodes (410) and a series of electromagnets (412) are spaced intermittently around the reactor (400). Taken together, electrodes (410) and electromagnets (412) provide one example of the agitator (112) illustrated in FIG. 1. The electrodes (410) by default are placed in contact with the metallic media (104) to ensure electrical continuity and may be comprised of copper electrodes with corrosion-resistant coatings such as tungsten, tantalum, among others. The magnets and electromagnets (412) are placed behind a protective liner directly in contact with the metallic media (104). Depending upon temperature, this liner may be comprised of a thermoplastic or ceramic materials.

The reactor (400) promotes mass exchanges through a metallic media, including media that may be multi-media: more than a single liquid metal, more than just a liquid, but also solids. The reactor (400) promotes mass exchanges in three-dimensions via use of external inputs, particularly electrical current and magnetic fields, but are not limited to and may include acoustic means (e.g., ultrasonic). The illustrative embodiments provide reactors and methods where a gas is introduced, agitated, or moved, and eventually produce a useful product. In some illustrative embodiments, contactless methods that are compatible to liquid and semi-liquid metals provide an energetic mass exchange between the gas and liquid phases, e.g., electromagnetic mass exchanges using Lorentz forces.

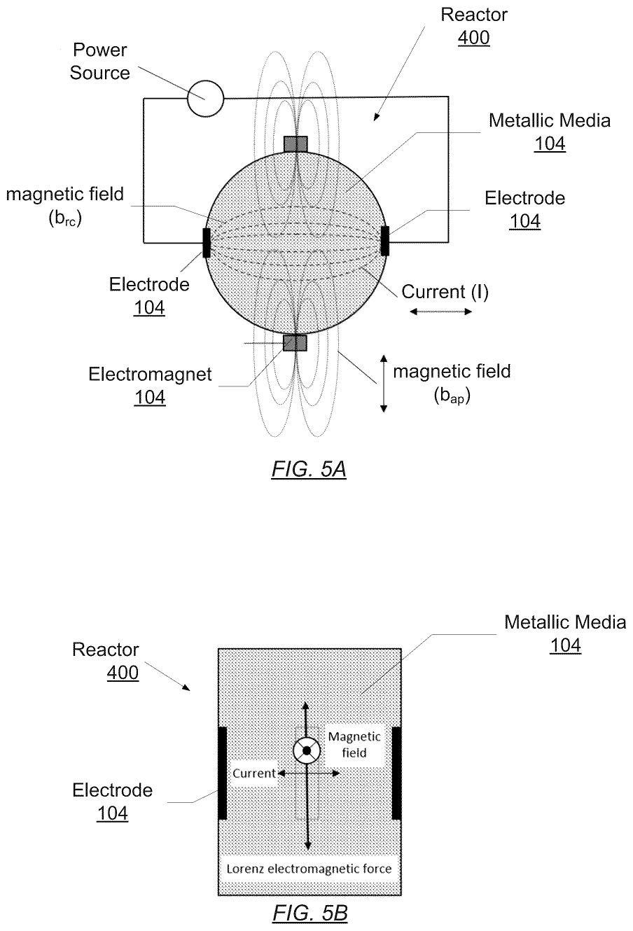

As explained in greater detail below in FIGS. 5A and 5B, metallic media (104) within the reactor (400) experiences a motive force due to the interaction between the magnetic field from the electromagnets (412), and the electric current applied across the electrodes (410). This force causes the metallic media (104) to move within the reactor (400). Flow rate of the metallic media (104) can be controlled by adjusting the strength of the magnetic field, and the current passing through the metallic media (104).

Referring now to FIG. 5A and FIG. 5B, a diagram of a reactor illustrating field lines of applied forces is shown according to illustrative embodiments. The reactor (400) is shown from a both a top view (FIG. 5A) and side view (FIG. 5B) thereof.

A current is fed through the metallic media (104) via electrodes (410). A magnetic field (b_{rc}) exists around the current (I)-carrying metallic media (104). The magnetic field associated with this current can be called “Reaction magnetic Field (b_{rc})”.

A pulse-amplitude modulated current source (FIG. 5A) can be used to maximize the agitation of the metallic media (104).

Electromagnets (412) are arranged to produce a magnetic field Bₐ. The two magnetic fields, the applied magnetic field Bₐₚ and the magnetic field produced by the conductor b_{rc}, generate a force perpendicular to the direction of I and Bₐₚ as the two fields attempt to align with each other. In other words, the metallic media (104) experiences a Lorentz force when subjected to an external magnetic field (Bₐₚ). This Lorentz force causes agitation of the metallic media (104).

The electromagnetically induced forces are remotely created, i.e., outside the reactor chamber, without physical contact with the metallic media (104). Both horizontal forces and vertical forces can be produced by perpendicular positioning of electrodes and magnets/electromagnets. These vertical forces and horizontal forces can be combined. When oriented vertically in a reactor, such as shown in FIG. 1, a vertical Lorentz electromagnetic force promotes high mass flow velocities, and breakdown of gas bubble. In this manner, the use of magnetic forces illustrated in figures four and five enables non-contact agitation of the metallic media (104) to drive the liquid metals and facilitate the formation of small gas bubbles. The agitation yields increased of carbon conversion efficiency as well as evacuation rates of reaction products and byproducts.

The reactor (100) of FIG. 5B and/or reactor (400) of FIGS. 5A and 5B can be used in a reactive metallurgical process for carbon conversion and/or capture in metallic media (104). The metallic media (104) can include post-transition metals, actinides, and lanthanides as well transition metals.

In some embodiments, the metallic media (104) may include one or more post-transition metals, The post-transition metal can be selected from the group consisting of gallium, indium, lead, thallium, tin, bismuth, mercury, and combinations thereof. The post-transition metal can include an alloy of an alkali metal, and/or alkaline earth metal. In some embodiments, the alkali metal is selected from the group consisting of lithium, sodium, potassium, rubidium, cesium, francium, and combinations thereof. In certain embodiments, the alkaline earth metal is selected from the group consisting of beryllium, magnesium, calcium, strontium, barium, radium, and combinations thereof.

In some embodiments, the metallic media (104) includes up to 99.9% post-transition metal by weight. for example, the liquid metal may include amounts of about 50%, about 60%, about 70%, about 80%, about 90%, about 95%, about 97%, or about 99%, by weight, of the post-transition metal.

In some embodiments, the metallic media (104) may include one or more actinide metals. The actinide metal can be selected from the group consisting of neptunium, plutonium, americium, curium, berkelium, californium, einsteinium, fermium, mendelevium, nobelium, lawrencium, and combinations thereof.

In some embodiments, the metallic media (104) may include one or more lanthanide metals. The lanthanide metal can be selected from the group consisting of lanthanum, cerium, praseodymium, neodymium, promethium, samarium, europium, gadolinium, terbium, dysprosium, holmium, erbium, thulium, ytterbium, lutetium, and combinations thereof.

In some embodiments, the metallic media (104) may include one or more transition metals. The transition metal can be selected from the group consisting of scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, hafnium, tantalum, tungsten, rhenium, osmium, iridium, platinum, gold, mercury, actinium, rutherfordium, dubnium, seaborgium, bohrium, hassium, meitnerium, darmstadtium, roentgenium, copernicium and combinations thereof.

The metallic media (104) may include a minimum of two metallic media. An immiscibility layer may be formed between the liquid or semi-liquid media. In other words, a third liquid of intermediate composition may exist in between the two metallic media under stagnant (i.e., unagitated) conditions.

The liquid metal includes less than 99.9% by weight of actinide metals, lanthanide metals, and transition metals. for example, the liquid metal may include amounts of about 50%, about 40%, about 30%, about 20%, about 10%, about 5%, about 3%, or about 1%, by weight, of the actinide metals, lanthanide metals, and transition metals.

The metallic media (104) may not be dispersed in other non-metallic liquids. Rather, the metallic media (104) is provided alone in liquid or semi-liquid (semi-solid), or in combinations with other liquid or semi-liquids.

Optionally, the metallic media (104) may include one or more complementary media. The complementary media (104) may be metallic, ionic (salt), inorganic (including polar), etc. The complementary media may have lower density than the metallic media (104).

The complementary media may include one or more inorganic fluids. For example, the complementary media may include fluids such as Ammonia, Dimethyl Benzyl Ammonium Chloride, etc.

In some embodiments, the complementary media may be an alloy formed using a mixture of base metal or alloy such as gallium and a catalytic metal salt. In some embodiments, the catalytic metal salt is selected from the group consisting of a catalytic metal chloride, catalytic metal fluoride, catalytic metal bromide, catalytic metal iodide, catalytic metal nitrate, catalytic metal triflate and combinations thereof.

For example, the complementary media include liquid or aqueous salts having an appropriate melting point under reaction conditions. For example, suitable salts can include chloride salts such as KCl, NaCl, CuCl, CaCl₂), MgCl₂, SnCl₂, BiCl₂, AlCl₃, AgCl₃, GaCl₃, LiNaK, CaLiNaK; non-chloride salts such as NaNO₃, KNO₃; bromide salts; and other suitable salts such as those listed in Table 2.

TABLE 2
Exemplary Chloride Salts

| | Melting Point | Boiling Point |
|---|---|---|
| Chloride Salt | (° C.) | (° C.) |
| NaCl | 800 | 1413 |
| KCl | 770 | 1420 |
| LiCl | 605 | 1382 |
| CaCl₂ | 772 | 1935 |
| FeCl₂ | 667 | 1023 |
| FeCl₃ | N/A | 315 |
| MgCl₂ | 714 | 1412 |
| MnCl₂ | 654 | 1225 |
| CuCl | 426 | 1490 |
| CuCl₂ | 498 | 993 |
| ZnCl₂ | 293 | 732 |
| AlCl₃ | 120 | 262 |

For example, the complementary media include liquid or aqueous salts mixtures having an appropriate melting point under reaction conditions. For example, suitable salt mixtures can include compositions such as those listed in Table 3.

TABLE 3
Exemplary Salt Mixtures

| | | Chemical Formula | | | | |
|---|---|---|---|---|---|---|
| | | NaCl | KCl | ZnCl₂ | MgCl₂ | |
| | | Density (g/cm³ @ 25° C.) | | | | |
| | | 2.16 | 1.98 | 2.91 | 2.32 | |
| | | Melting Point (° C.) | | | | |
| | | 801 | 770 | 292 | 714 | |
| | | Boiling Point (° C.) | | | | Theoretical |
| | | 1413 | 1420 | 732 | 1412 | Melting |
| | | Molar Mass (g/mol) | | | | Point |
| | | 58.44 | 74.55 | 136.32 | 95.21 | (° C.) |
| #1 | Molar Fraction | 13.8% | 41.9% | 44.3% | | 229 |
| | Mass Fraction | 8.1% | 31.3% | 60.6% | | |
| #2 | Molar Fraction | 18.6% | 21.9% | 59.5% | | 213 |
| | Mass Fraction | 10.0% | 15.1% | 74.9% | | |
| #3 | Molar Fraction | 13.4% | 33.7% | 52.9% | | 204 |
| | Mass Fraction | 7.5% | 23.9% | 68.6% | | |
| #4 | Molar Fraction | 27.5% | 32.5% | | 40.0% | 383 |
| | Mass Fraction | 20.5% | 30.9% | | 48.6% | |
| #5 | Molar Fraction | 30.0% | 20.0% | | 50.0% | 396 |
| | Mass Fraction | 21.9% | 18.6% | | 59.5% | |
| #6 | Molar Fraction | | 68.0% | | 32.0% | 430 |
| | Mass Fraction | | 62.5% | | 37.5% | |

In some embodiments, pressure greater ambient and temperatures above ambient are applied to one or more reactor chambers may be continuously or periodically. For example, super-atmospheric pressures and/or super-ambient temperatures may facilitate miscibility of the complementary media and/or solubility of the intermetallic clusters.

In some embodiments, intermetallic catalytic clusters disposed in the metallic media (104). The intermetallic catalytic clusters can be formed in-situ within the metallic media (104) during processing or use. By subjecting a metal alloy to a specific temperature and time, the atoms can rearrange themselves into ordered clusters of intermetallic compounds. In-situ formation offers several advantages over traditional methods of intermetallic cluster synthesis, including improved control over the cluster size, distribution, and composition, as well as reduced costs and processing times.

The intermetallic clusters may provide catalytic sites in various carbon reduction reactions due to their unique properties and structure. Intermetallic clusters can have high surface areas and can be tuned to have specific catalytic properties based on their composition, size, and structure. This surface areas may enable the intermetallic clusters to promote chemical reactions more efficiently than other catalysts, such as metals or metal oxides.

The intermetallic clusters may have any suitable median diameter. For example, the intermetallic clusters may have a median diameter of less than about 1000 nm, about 800 nm, about 500 nm, about 300 nm, 200 nm and about 100 nm. In one particularly preferred embodiment, metallic clusters may have a median diameter of between about 100 nm and about 200 nm.

In some embodiments, the intermetallic clusters include one or more metals or metalloid elements that are soluble within the metallic media (104) under reaction conditions (i.e., temperature and pressure). Intermetallic clusters having greater solubility at lower temperatures may enable more efficient carbon conversion under some reactor conditions.

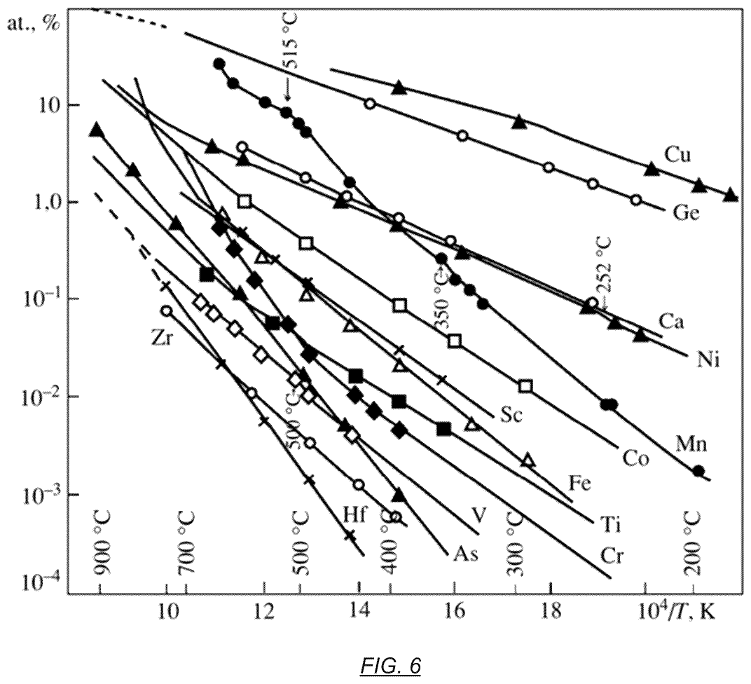

For example, FIG. 6 illustrates the temperature dependence of intermetallic cluster solubility in a gallium media. In the example of FIG. 6, the intermetallic clusters may include one or more of copper, germanium, calcium, nickel, manganese, cobalt, scandium, iron, titanium, chromium, vanadium, arsenic, hafnium, and zirconium. In other examples, the intermetallic clusters may include one or more of, palladium, platinum, gold, silver, ruthenium, rhodium, and iridium. As shown in FIG. 6, the solubility of copper and germanium may be particularly well suited for the gallium-media.

Therefore, in some embodiments, reaction conditions may benefit from a minimum temperature dependent on compositions of the metallic media (104). For example, the minimum temperature to induce carbon reduction may be greater than about 20, greater than about 25, greater than about 30, greater than about 40, greater than about 50 or greater than about 100° C., on the composition of the metallic media (104). The minimum temperature may be at least 23° C. under 1 atmosphere pressure.

Therefore, in some embodiments, reaction conditions may benefit from a certain column pressure dependent on compositions and temperatures of the metallic media (104). For example, the column pressure may be about greater than 10, greater than. 15, greater than 20, greater than 25, or greater than 30 psi per meter. In another example, the column pressure may be less than 50, less than 45, less than 40, less than 35, less than 30, or less than 20 psi per meter. In one preferred embodiment, the column pressure between 20 to 35 psi per meter at 23° C. and under 1 atmosphere,

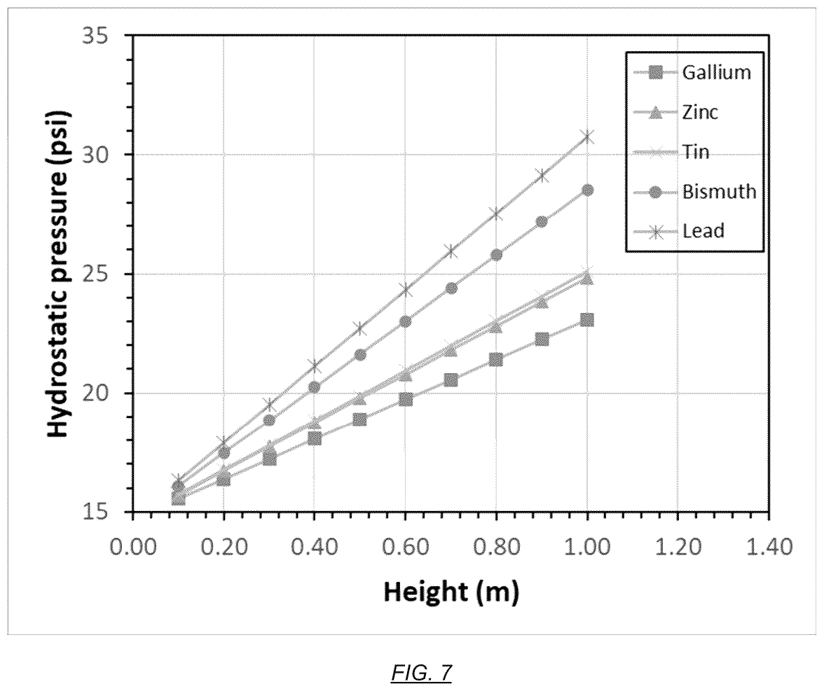

For example, as shown in FIG. 7, in some embodiments, the metallic media (104) of FIG. 1 is a liquid or semi-solid media with a minimum temperature of 23° C. under 1 atmosphere that produces a column pressure in the range of 20 to 35 psi per meter.

In some embodiments, the metallic media (104) FIG. 1 may include one or more binary, tertiary (or other) eutectic systems. As is generally defined in the art, a eutectic system is a type of mixture of two or more elements or compounds that has a lower melting point than any of the individual components. When the components are mixed in the correct proportions, the resulting mixture will melt at a temperature lower than the melting point of either component alone.

Examples of compositions of eutectic systems well as their solidus and liquidus properties, are provided in Table 4.

TABLE 4
compositions of eutectic systems

| | | Solidus | Liquidus | | Specific |
|---|---|---|---|---|---|
| Alloy category | Composition | (° C.) | (° C.) | Note | gravity |
| Sn—Pb | 63/37 | 183 | 183 | Eutectic | 8.4 |
| Au—Sn | 80/20 | 280 | 280 | Eutectic | 14.51 |
| Bi—Cd | 60/40 | 144 | 144 | Eutectic | 9.31 |
| Bi—In | 67/33 | 109 | 109 | Eutectic | 8.81 |
| Bi—In—Sn | 57/26/17 | 79 | 79 | Eutectic | |
| Bi—Sn | 58/42 | 138 | 138 | Eutectic | 8.56 |
| In—Ag | 97/3 | 143 | 143 | Eutectic | 7.38 |
| In—Bi—Sn | 48.8/31.6/19.6 | 59 | 59 | Eutectic | |
| | 51.0/32.5/16.5 | 60 | 60 | Eutectic | 7.88 |
| In—Sn | 52/48 | 118 | 118 | Eutectic | 7.30 |
| Sn—Ag | 96.5/3.5 | 221 | 221 | Eutectic | 7.36 |
| Sn—Ag—Cu | 93.6/4.7/1.7 | 216 | 216 | Eutectic | |
| Sn—Cu | 99/1 | 227 | 227 | Eutectic | |
| Sn—Zn | 91/9 | 199 | 199 | Eutectic | 7.27 |

In some embodiments, a binary eutectic system can be selected from systems such as Sn—Bi, Bi—In, In—Sn, Ga—In, Bi—Ga, Bi—Pb, Sn—Pb, Zn—Bi, Zn—Sn, Sn—Ag, Sn—Cu, and Sn—Sb.

In some embodiments, a tertiary eutectic system can be selected from systems such as Bi—Sn—Ga, Sn—Bi—In, and Sn—Sb-Ci.

The behavior of a eutectic system can be visualized on a phase diagram, which shows the relationships between the temperature, pressure, and composition of the mixture. In a eutectic system, the melting point is the lowest possible temperature at which the mixture can exist in a liquid state. This temperature is known as the eutectic temperature. The composition of the mixture at the eutectic temperature is known as the eutectic composition. On the phase diagram, the eutectic point is the point at which the solid and liquid phases of the mixture have the same composition.

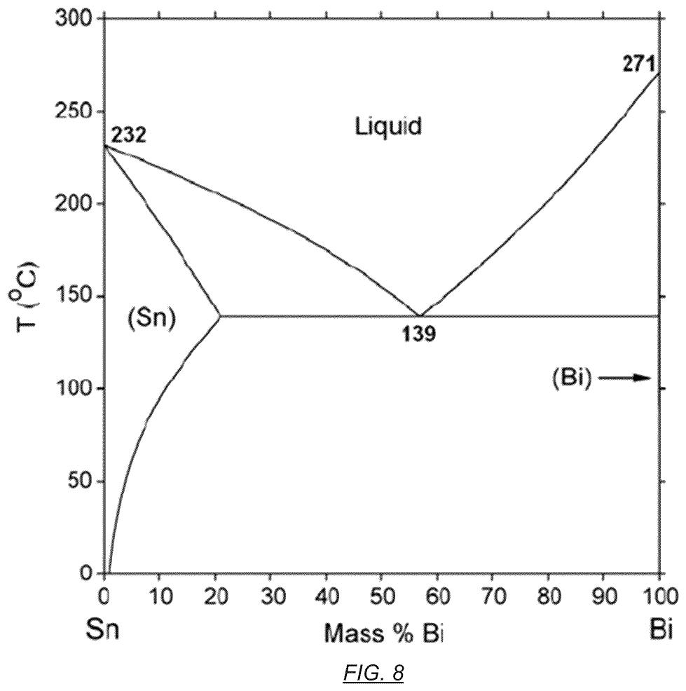

For example, a phase diagram for a tin-bismuth eutectic system is illustrated in FIG. 8. In the Sn—Bi semi-liquid (or semi-solid), solid and liquid phases coexist above 139° C., with exception of eutectic composition where liquid phase is present down to 139° C.

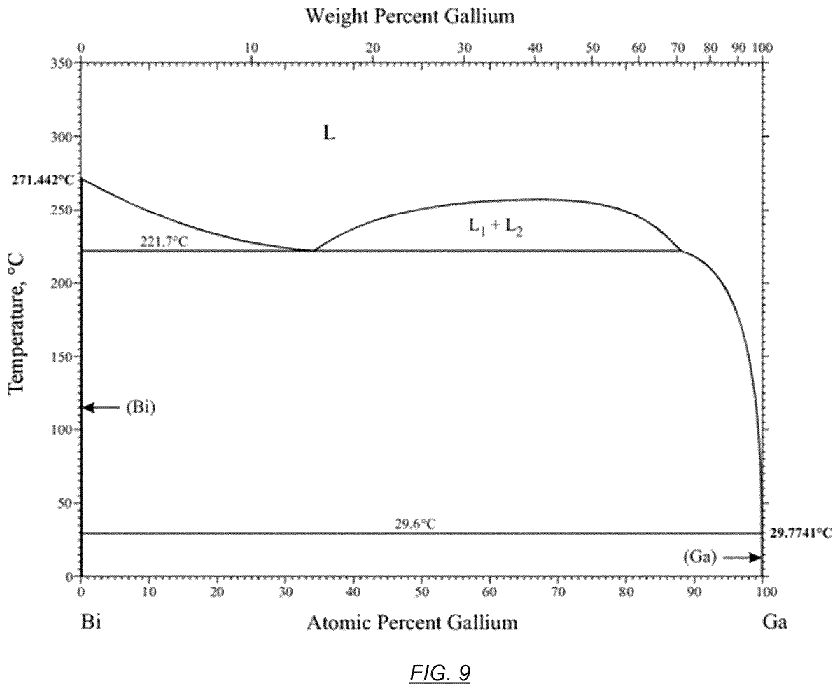

A phase diagram for a bismuth-gallium eutectic system is illustrated in FIG. 9. The of Bi—Ga system is an example of two liquids in equilibrium between 227 and 271° C. at compositions including 35 to 85 wt. % gallium,

A carbon gas is circulated in the metallic media (104) of FIG. 1. In the case of the molten-metal bubble column process for methane conversion, the gas introduced into the column is a mixture of methane (CH₄) and steam (H₂O). For carbon conversion, carbon dioxide (CO₂) is substituted for the methane. For example, in a gallium-based column, the general reactions of simple gases such as carbon dioxide and/or methane may be broadly defined as the following:

$${CO}_{2} {\to }^{Ga} C + {O}_{2} \qquad Eq . 1$$

$${CH}_{4} {\to }^{Ga} C + 2 {H}_{2} \qquad Eq . 2$$

Equations Eq. 1 and are simplified, and may encompass one or more intermediate reactions with the catalyst. For example, equation 1 may include:

$${CO}_{2} + Ga \to C + 2 {Ga}_{2} {O}_{3} \qquad Eq . 3$$

$${Ga}_{2} {O}_{3} \to 2 Ga + \frac{3}{2} {O}_{2} \qquad Eq . 4$$

In the presence of more complex liquids, either alloys and/or with catalysts, the carbon product may include other carbon molecular compounds, such as methanol (H₃COH), and/or carbon monoxide (CO), which has been observed in the CO₂ conversion in the presence of copper.

Optionally one or more second gas is allowed to flow through the metallic media (104) of FIG. 1. The second gas can be an inert or carrier gas, that does not participate in the carbon conversion reaction, such as nitrogen, argon, helium, etc.

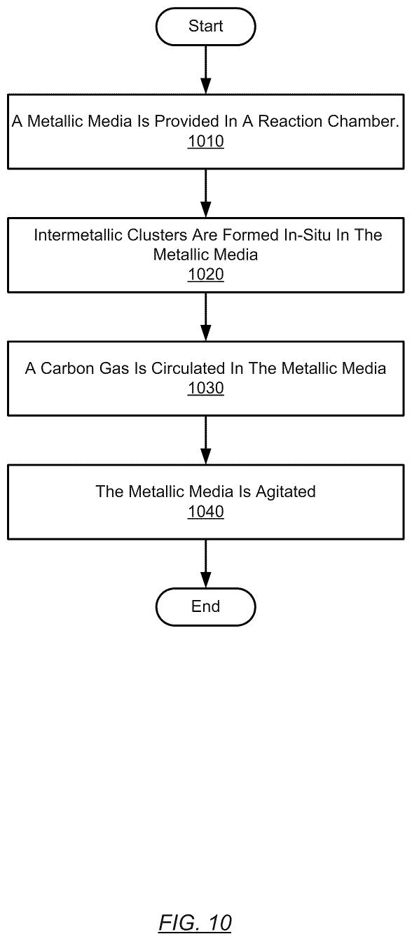

Turning to FIG. 10, a flow chart of a process for carbon conversion is shown according to one or more illustrative embodiments. the process of FIG. 10 can be used to perform a reactive metallurgical process for carbon capture and conversion in a reactor, such as the reactors illustrated in FIGS. 1-5. The following example is for explanatory purposes only and not intended to limit the scope of the invention.

At step 1010, a metallic media is provided in a reaction chamber. The metallic media can be a liquid, semi-liquid, or semi-solid, and can include post-transition metals, actinides, and lanthanides as well transition metals. In some embodiments, the metallic media may not include an organic solvent.

At step 1020, intermetallic clusters are formed in-situ in the metallic media. The intermetallic clusters may include one or more metals or metalloid elements such as silver, nickel, copper, and combinations thereof.

At step 1030, a carbon gas is circulated in the metallic media. The carbon gas can be carbon dioxide (CO₂) or methane (CH₄). Optionally, one or more second gasses, such as nitrogen, argon, helium, is also allowed to flow through the metallic media.

At step 1040, the metallic media is agitated. In some embodiments, a noncontact agitation source provides an energetic mass exchange to encourage task flow through the metallic media. For example, as illustrated in FIGS. 5A and 5B, a number of electrodes and electromagnets may be disposed along a surface of the reaction chamber. The metallic media within the chamber experiences a motive Lorentz force due to the interaction between the magnetic field from the electromagnets and the electric current applied across the electrodes, thereby causing agitation of the metallic media.

While the various steps in this flowchart are presented and described sequentially, at least some of the steps may be executed in different orders, may be combined, or omitted, and at least some of the steps may be executed in parallel. Furthermore, the steps may be performed actively or passively.

Illustrative embodiments herein describe methods and systems for producing solid carbon from carbon dioxide and/or hydrocarbons such as methane (CH₄). One or more liquid or semi-liquid media A metallic media, either in liquid or semi-liquid (semi-solid) form is used alone or in combinations with other liquid or semi-liquid metals. In a reactive metallurgical process for carbon capture and conversion, catalytic intermetallic clusters are formed in-situ, and a mass flow of carbon-rich fluid is introduced.

The reactor system for carbon capture and conversion may incorporate multiple process chambers and novel methods of media blending the semi-liquid media to accelerate carbon conversion. The systems make use of contactless induction methods that are uniquely compatible with liquid and semi-liquid metals to controllably produce mass flow in desired directions, thereby improving overall process capture and conversion efficiency.

Unless otherwise defined, terms of art, notations and other scientific terms or terminology used herein are intended to have the meanings commonly understood by those of skill in the art to which this disclosure pertains. In some cases, terms with commonly understood meanings are defined herein for clarity and/or for ready reference, and the inclusion of such definitions herein should not necessarily be construed to represent a substantial difference over what is generally understood in the art. It will be further understood that terms, such as those defined in commonly used dictionaries, should be interpreted as having a meaning that is consistent with their meaning in the context of the relevant art and/or as otherwise defined herein.

The terminology used herein is for the purpose of describing particular implementations only and is not intended to be limiting.

When used with respect to a composition, the terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of the stated amount.

When used with respect to a physical property that may be measured, the term “about,” refers to an engineering tolerance expected by or determined by one ordinary skill in the art. The exact quantified degree of an engineering tolerance depends on the product being produced, the process being performed, or the technical property being measured. For a non-limiting example, two angles may be “about congruent” if the values of the two angles are within ten percent of each other. However, if the ordinary artisan determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product, and thus is capable of assessing how to determine the variance of measurement contemplated by the term “about.”

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such, includes the term “and.” Further, items joined by the term “or” may include any combination of the items with any number of each item, unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A reactive metallurgical process for carbon capture and conversion comprising:
a metallic media, wherein the metallic media is a liquid, semi-liquid, or semi-solid;
intermetallic catalytic clusters formed in-situ and disposed in the metallic media; and
a carbon gas circulating in the metallic media.

2. The reactive metallurgical process of claim 1, wherein the metallic media includes post-transition metals, actinides, and lanthanides as well as transition metals, and
wherein the metallic media does not include an organic solvent.

3. The reactive metallurgical process of claim 1, further comprising:
one or more complementary media, wherein the one or more complementary media is one of metallic and non-metallic, and wherein the one or more complementary media has a lower density than the metallic media; and
an optional second gas that is allowed to flow through the metallic media.

4. The reactive metallurgical process of claim 3, wherein the one or more complementary media have lower density than the metallic media.

5. The reactive metallurgical process of claim 4, wherein the one or more complementary media is selected from the group consisting of metallic, ionic, inorganic, and combinations thereof.

6. The reactive metallurgical process of claim 4, wherein the one or more complementary media include inorganic fluids.

7. The reactive metallurgical process of claim 1, wherein the metallic media comprises is selected from the group consisting of gallium, indium, bismuth, lead, tin, and combinations thereof.

8. The reactive metallurgical process of claim 1, wherein the metallic media comprises one or more binary eutectic systems.

9. The reactive metallurgical process of claim 1, wherein the intermetallic catalytic clusters comprise one or more metals or metalloid elements selected from the group consisting of silver, nickel, copper, and combinations thereof.

10. The reactive metallurgical process of claim 1, wherein a liquid or semi-solid media has a minimum temperature of 23° C. under 1 atmosphere and produces a column pressure in a range of 20 to 35 psi per meter.

11. The reactive metallurgical process of claim 7, wherein the metallic media is a first metallic media, the process further comprising:
at least one second metallic media that is immiscible with the first metallic media, wherein a third liquid of intermediate composition is formed between the first metallic media and the second metallic media under unagitated conditions.

12. The reactive metallurgical process of claim 10, wherein a pressure greater than atmospheric and a temperature above ambient are applied continuously or periodically to the metallic media.

13. A reactor for the capture and conversion of a carbon gas/fluid comprising:
one or more chambers where one or more metallic medias are contained in controlled conditions;
one or more inlets to introduce a carbon gas; and
one or more agitators to promote gas—media reactions and product separation.

14. The reactor of claim 13, wherein the one or more chambers are configured in series and/or parallel and complemented by standard fluidic equipment including at least one of pumps, valves, regulators, pressure gauges, or temperature gauges.

15. The reactor of claim 13, wherein fluid agitation is supplied using magnetic, electric, or mechanical means to accelerate reactive processes, carbon capture, and conversion kinetics.

16. The reactor of claim 13, wherein the carbon gas is introduced through static mechanical inlets or dynamic mechanical means.

17. The reactor of claim 13, wherein the metallic media is fed over arrays of plates in a carbon-gas environment, and wherein resulting movement and reaction of the metallic media accumulates and segregates carbon product towards one or more chamber of the one or more chambers.

18. The reactor of claim 13, further comprising:
a number of electrodes disposed along a surface of a chamber; and
a number of electromagnets disposed along the surface of the chamber;
wherein an interaction between a magnetic field from the electromagnets and an electric current applied across the electrodes, in a continuous or a pulse-amplitude modulated mode, induces electromagnetic forces causing agitation of the metallic media.

19. The reactor of claim 13, wherein induced electromagnetic forces are remotely created without physical contact with the metallic media to drive agitation of the metallic media and facilitate a formation of gas bubbles.

20. The reactor of claim 17, wherein the electromagnetically induced forces comprise vertical forces that are produced by perpendicular positioning of electrodes and magnets/electromagnets.

21. The reactor of claim 20, wherein the electromagnetically induced forces comprise horizontal forces that are produced by perpendicular positioning of electrodes and magnets/electromagnets, wherein vertical forces and horizontal forces are combined in a continuous or a pulse-amplitude modulated mode to maximize the mixing of the metallic media.
